(19) United States
(12) Patent Application Publication
(10) Pub. No.: US 2003/0146842 A1
(43) Pub. Date: Aug. 7, 2003

(54) Heat detector

(76) Inventor: Chi-Chang Liu, Feng-Yuan City (TW)

Correspondence Address: HEDMAN & COSTIGAN, P.C., 1185 Avenue of Americas, New York, NY, 10036, US

(21) Appl. No.: 10/072,024

(22) Filed: Feb. 7, 2002

(51) Int. Cl. G08B 17/00

(52) U.S. Cl. 340/584

(57) ABSTRACT

The present invention has a microprocessor, a head sensor, a graphic display and a keypad. When a distance between the heat sensor and heat source changes, a frequency of a wave pattern shown on the graphic display has high and low states. The user just sees the graphic display to clearly know whether the heat source close to the body from the frequency of wave pattern changing. Besides the heat detector further has at least one laser diode to point a position corresponding to the location of the heat source and an alarm unit to warn the user that the heat source is closing.

### BACKGROUND OF THE INVENTION

1. Field of the Invention

The present invention is related to a heat detector, and more particularly to a heat detector that provides a clear wave pattern to show a user a corresponding distance between the heat detector and a heat source.

2. Description of Related Art

When people participate in field activities, they use heat detectors to detect animals around them to protect themselves. Furthermore, the heat detector is also used to detect injured or trapped people in disaster areas.

With reference to FIG. 6, a conventional heat detector comprises a microprocessor (50), a heat sensor (51), an indicator (52) and an alarm unit (54). The microprocessor (50) has multiple input ports and output ports. The heat sensor (51) is connected to an input port of the microprocessor (50). The indicator (52) is connected to an output port of the microprocessor (50) and has multiple LEDs arranged in order. The alarm unit (54) is connected to an output port of the microprocessor (50).

The heat sensor (51) in the heat detector detects heat from a heat source and outputs an electronic detecting signal to the microprocessor (50). When the microprocessor (50) receives the detecting signal from the heat sensor (51), the microprocessor (50) turns on LEDs (521) in the indicator (52) to show the strength of the detecting signal. The number of the LEDs (521) turned on is determined by the strength of the detecting signal being above preset values in the microprocessor (50). When the detecting signal is below a preset value, less LEDs are turned on. However, quickly determining whether or not the heat source is close to the user with the foregoing indicator (52) is not done easily. Furthermore, the heat source does not always stay in a fixed position, and the heat source is able to move to another position while the user is watching the detected states shown on the indicator (52). Therefore, using this heat detector to find a heat source is difficult.

Therefore, an objective of the present invention is to provide an improved heat detector to provide clear detection states on the display to the user to mitigate and/or obviate the aforementioned problems.

### SUMMARY OF THE INVENTION

The main objective of the present invention is to provide a heat detector that provides a clear graph reflecting detected states so the user can easily know the detected states.

Other objectives, advantages and novel features of the invention will become more apparent from the following detailed description when taken in conjunction with the accompanying drawings.

### BRIEF DESCRIPTION OF THE DRAWINGS

FIG. 1 is block diagram of a heat detector in accordance with the present invention;

FIGS. 2A to 2D are circuit diagrams of the heat detector in accordance with the present invention;

FIG. 3 is a perspective view of the heat detector in accordance with the present invention;

FIGS. 4 is a front plane view of the heat detector in FIG. 3;

FIGS. 5A and 5B are operational side plan view of the heat detector in FIG. 3; and

FIG. 6 is a block diagram of a conventional heat detector.

### DETAILED DESCRIPTION OF THE PREFERRED EMBODIMENT

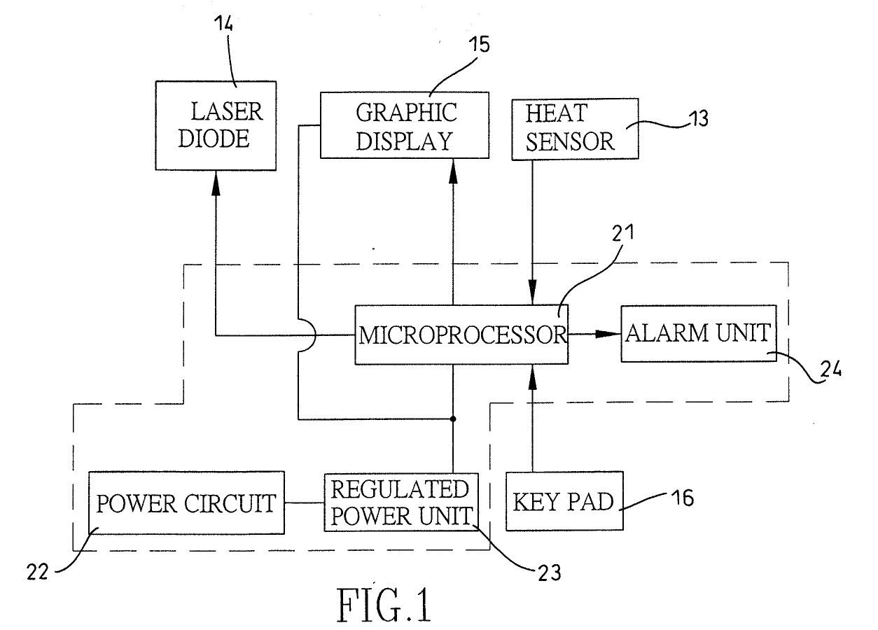

With reference to FIG. 1, a heat detector in accordance with the present invention comprises a microprocessor (21), a heat sensor (13), at least one laser diode (14), a graphic display (15), an alarm unit (24), a keypad (16), a power circuit (22) and a regulated power unit (23).

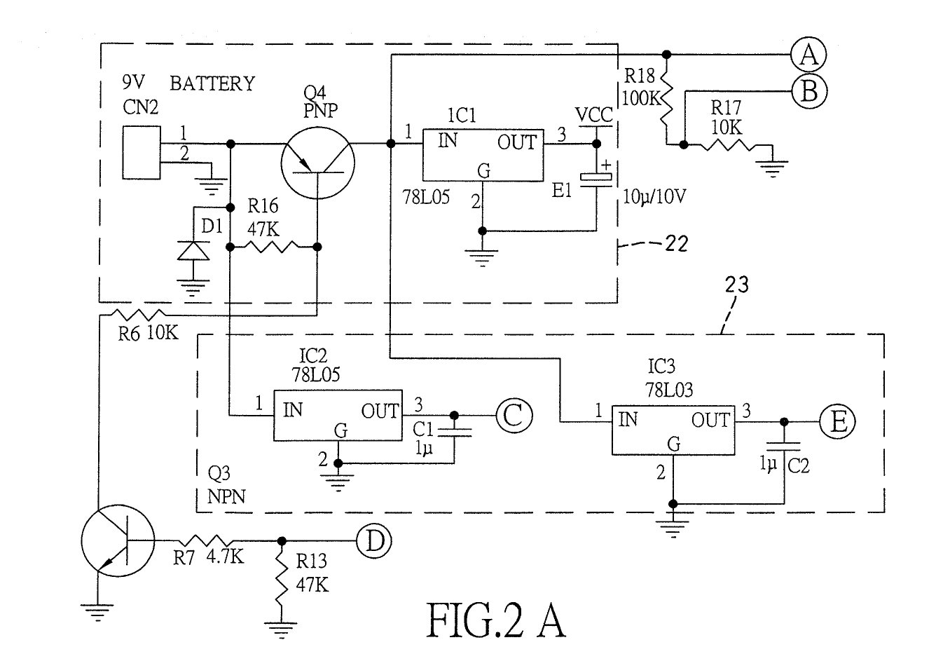

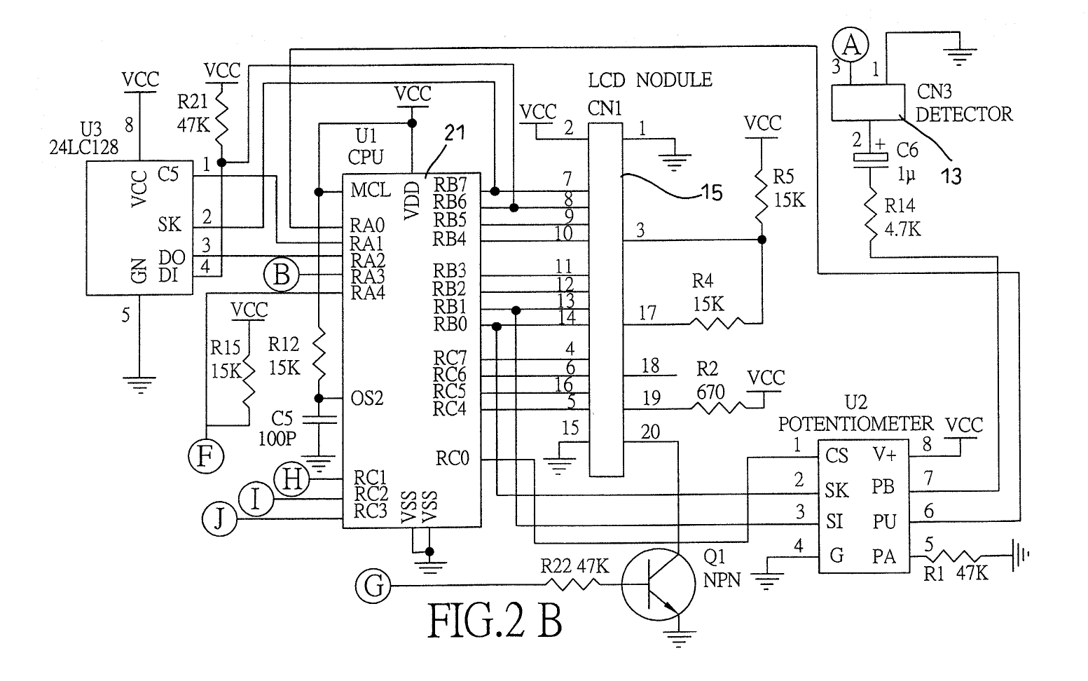

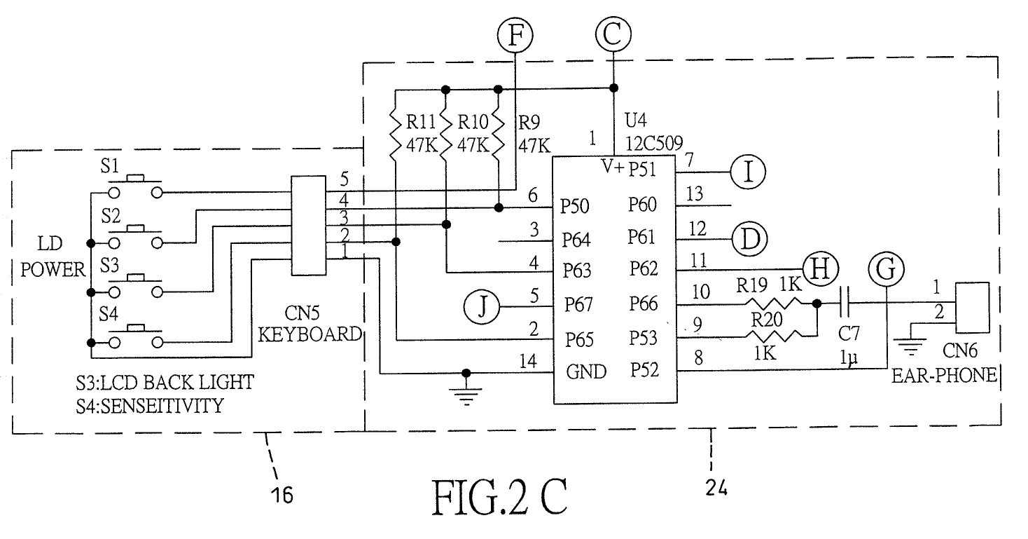

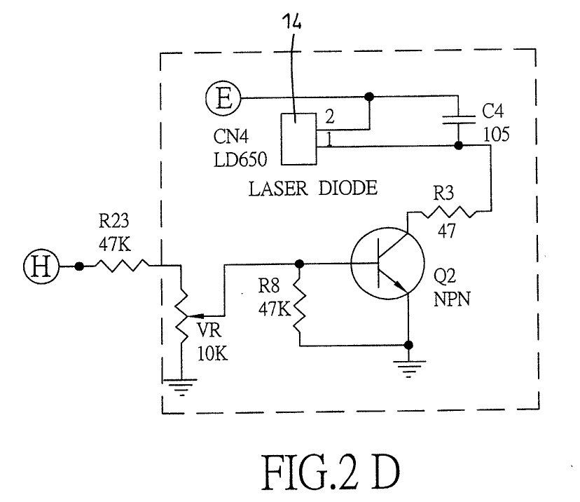

With reference to FIGS. 2A to 2D, the microprocessor (21) has multiple input ports and output ports. The heat sensor (13) connected to an input port of the microprocessor (21) detects heat from a heat source (not shown), and then outputs an electronic detecting signal to the microprocessor (21). The graphic display (15), such as an LCD display, connected to an output port of the microprocessor (21) displays a wave pattern. The laser diode (14) connected to an output port of the microprocessor (21) outputs laser light to point at the specific heat source. The power circuit (22) connects to the microprocessor (21) through the regulated power unit (23) supplies the DC power to the alarm unit (24), the laser diode (14) and the keypad (16). The keypad (16) connects to an input port of the microprocessor (21). When the heat sensor detects that a heat source is closing, the microprocessor (21) causes the alarm unit (24) to turn on to warn the user.

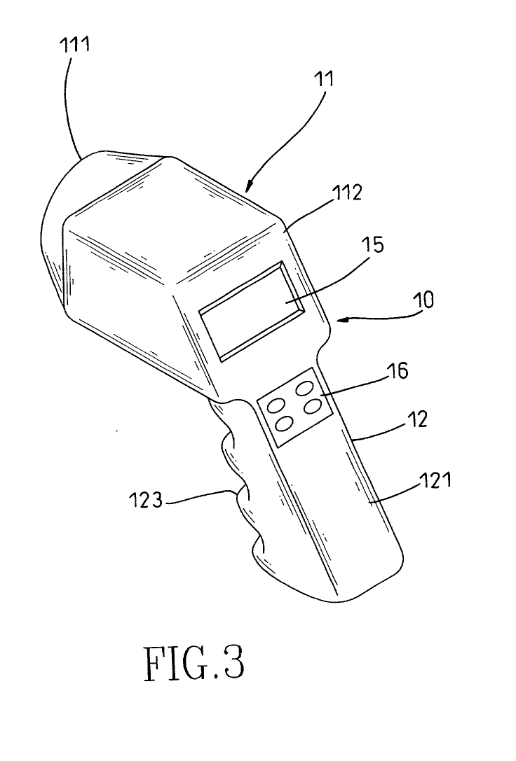

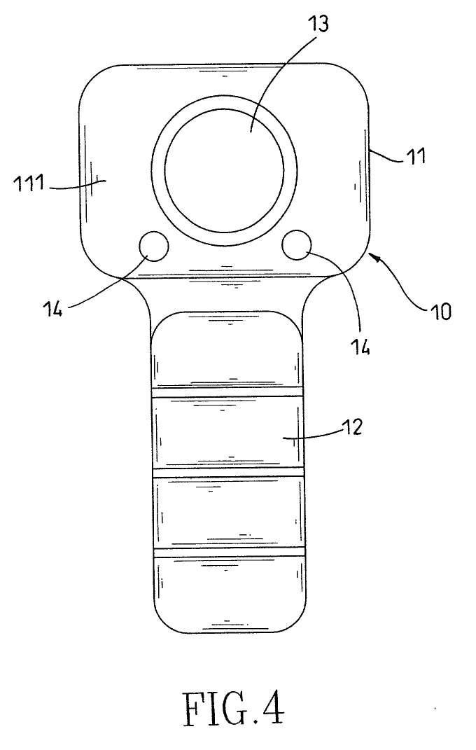

With reference to FIGS. 3 and 4, the heat detector device is further comprised of a case (10) with a head (11) and a handle (12). The head (11) has a sensor end (111) and a display end (112). The handle (12) has a grip (123) and a control face (121) corresponding to the display end (112) of the head (11). The graphic display (15) is mounted in a window (not numbered) on the display end (112) of the head (11). The heat sensor (13) and the laser diode (14) are mounted in corresponding openings (not numbered) on the sensor end (111) of the head (11). The keypad (16) is mounted in an opening in the control face (121) of the handle (12) below the window for the graphic display (15).

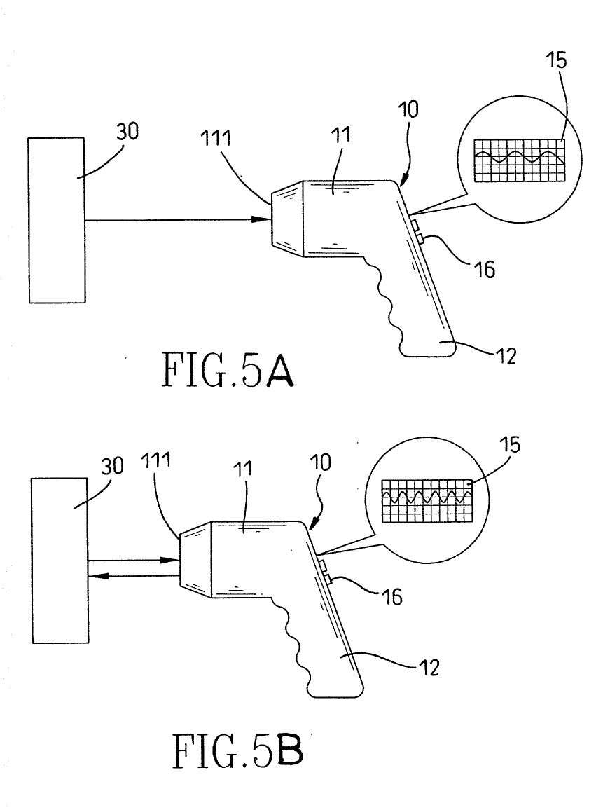

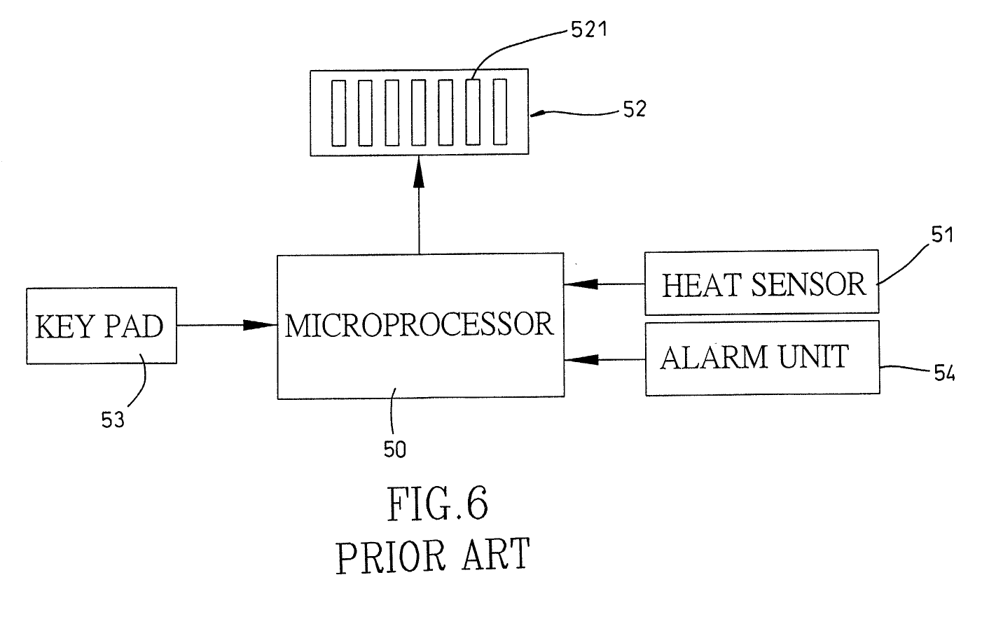

With reference with FIG. 5A, when a heat source (30) is within an effective range of the heat sensor (not shown), the heat sensor detects the heat from the heat source (30). Immediately following the detection of the heat source (30), a sine wave is presented on the graphic display (15). The sine wave has a frequency and an amplitude. The amplitude is fixed, but the frequency varies depending on the strength of the heat source detected. If a distance between the heat detector and the heat source (30) is close, as shown in FIG. 5B, the frequency of the sine wave will be high. With the sensor face (111) pointed in the direction that displays the sine wave with the highest frequency, pressing the corresponding key (not numbered) on the keypad (16) turns on the laser diode (not shown) that points to a position corresponding to the location of the heat source (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat detector comprising:
a microprocessor having multiple input ports and output ports;
a heat sensor connected to an input port of the microprocessor to detect heat from a heat source;
a graphic display connected to an output port of the microprocessor to display a wave pattern; and
a keypad connected to an input port of the microprocessor to select the specific functions of the heat detector; wherein
when a distance between the heat source and the heat sensor changes, a frequency of the wave pattern presented on the graphic display has high and low states.

2. The heat detector as claimed in claim 1, wherein the heat detector further comprises at least one laser diode connected to an output port of the microprocessor to point at the heat source.

3. The heat detector as claimed in claim 2, wherein the heat sensor, the graphic display, the laser diode and the keypad are mounted in a case having a head with a sensor end and a display end and a handle, where the heat sensor is mounted on the sensor end of the head, the graphic display is mounted on the display end of the head and the keypad is mounted on the handle.

4. The heat detector as claimed in claim 1, wherein the graphic display is a LCD display.

5. The heat detector as claimed in claim 1, wherein an output port of the microprocessor further connects to an alarm unit to warn the user that the heat source is closing.
